(19) United States
(12) Patent Application Publication
(10) Pub. No.: US 2024/0322702 A1
(43) Pub. Date: Sep. 26, 2024

(54) Phase-Shifted Full Bridge Topology With Energy Optimized Current Injection

(71) Applicant: Rompower Technology Holdings, LLC, Milford, DE (US)

(72) Inventor: Ionel Jitaru, Tucson, AZ (US)

(73) Assignee: Rompower Technology Holdings, LLC, Milford, DE (US)

(21) Appl. No.: 18/733,812

(22) Filed: Jun. 4, 2024

Related U.S. Application Data
(63) Continuation-in-part of application No. 18/236,875, filed on Aug. 22, 2023.
Application No. 18/236,875 is a continuation of application No. 17/496,861, filed on Oct. 8, 2021, now Pat. No. 11,736,029.
Application No. 17/496,861 is a continuation of application No. 16/407,905, filed on May 9, 2019, now Pat. No. 11,146,177.
Application No. 16/407,905 is a continuation-in-part of application No. 15/987,499, filed on May 23, 2018, now Pat. No. 10,291,140.
Application No. 15/987,499 is a continuation-in-part of application No. 15/899,243, filed on Feb. 19, 2018, now Pat. No. 10,050,545.
Application No. 15/899,243 is a continuation of application No. 15/825,647, filed on Nov. 29, 2017, now Pat. No. 11,152,847.
Application No. 15/825,647 is a continuation of application No. 15/068,598, filed on Mar. 13, 2016, now Pat. No. 9,985,546.
Application No. 15/899,243 is a continuation of application No. 14/890,088, filed on Nov. 9, 2015, now Pat. No. 9,899,929.
Application No. 15/899,243 is a continuation of application No. 14/274,701, filed on May 10, 2014, now Pat. No. 10,103,639.
Application No. 15/987,499 is a continuation of application No. 14/796,204, filed on Jul. 10, 2015, now Pat. No. 10,205,397.
(60) Provisional application No. 62/429,373, filed on Dec. 2, 2016.
(60) Provisional application No. 62/591,594, filed on Nov. 28, 2017.
(60) Provisional application No. 62/587,816, filed on Nov. 17, 2017.
(60) Provisional application No. 62/133,245, filed on Mar. 13, 2015.
(60) Provisional application No. 61/821,902, filed on May 10, 2013.
(60) Provisional application No. 61/821,896, filed on May 10, 2013.
(60) Provisional application No. 62/023,025, filed on Jul. 10, 2014.

(51) Int. Cl. H02M 3/335; H02M 1/08

(52) U.S. Cl. CPC H02M 3/33592; H02M 1/08

(57) ABSTRACT

In an embodiment, the specification describes power converters using soft switching in phase shifted full bridge topology wherein a current injection method is used to obtain zero voltage switching on all the primary switchers in all the operating conditions, wherein the amplitude of current injection is substantially decreased by creating a very good coupling between the primary of the transformer and the current injection winding, while creating a leakage inductance in between the secondary winding and said primary winding the current injection winding. The current injection is activated when the energy contained in the leakage inductance between primary and secondary is not enough to create zero voltage switching conditions for the switching elements. Once activated, the current injection flows preferentially towards the primary winding, discharging the parasitic capacitance reflected across primary switching elements of the resonant leg.

### CROSS-REFERENCE TO RELATED APPLICATIONS

This application is a continuation-in-part of and claims the benefit of prior U.S. patent application Ser. No. 18/236,875, filed Aug. 22, 2023, which is a continuation of and claims the benefit of prior U.S. patent application Ser. No. 17/496,861, filed Oct. 8, 2021, which is a continuation of and claims the benefit of prior U.S. patent application Ser. No. 16/407,905, filed May 9, 2019, which is a continuation in part of and claims the benefit of U.S. patent application Ser. No. 15/987,499, filed May 23, 2018, which, in turn, is a continuation-in-part of and claims the benefit of U.S. patent application Ser. No. 15/068,598 filed Mar. 13, 2016, which claims priority from the U.S. Provisional Patent Application No. 62/133,245 filed Mar. 13, 2015.

The disclosure of each of the above-identified patent applications is incorporated herein by reference.

### FIELD

The present specification relates generally to power conversion, and more particularly to power converters using soft switching in phase-shifted full bridge topology with current injection.

### BACKGROUND

There have been many innovative solutions developed over the years to ensure zero voltage switching in the phase shifted full bridge topology. In U.S. Pat. No. 6,862,195, for example, zero voltage switching is generally accomplished by forcing the current flowing through the secondary switching elements to reach zero before the polarity of the voltage in the secondary changes. This solution is most applicable in low current and higher voltage applications.

In U.S. Pat. No. 5,126,931, zero voltage switching is generally accomplished by creating a virtual leakage inductance through the use of a nonlinear inductive element placed in series with the secondary winding. In U.S. Pat. No. 7,009,850, zero voltage switching is generally accomplished through a voltage injection in the transformer which superimposes on the voltage induced by the primary switchers and forces the current through the secondary switching elements to turn off before the voltage changes the polarity in the secondary. This solution works for a continuous conduction mode through the output inductor but requires an additional transformer, which increases the cost and size of the converter. U.S. Pat. No. 5,198,969 generally presents a phase shifted full bridge wherein additional inductive elements are added in series with the primary winding in order to create a larger virtual leakage inductance.

A larger leakage inductance in the transformer can decrease the effective duty cycle and increase circulating current which negatively impacts efficiency. A larger leakage inductance in the transformer, which is a preferred path in some applications, is in conflict with a high efficiency transformer. In the quest for higher efficiency, a very high efficiency transformer is paramount.

In conventional phase-shifted full bridge topologies, zero voltage switching cannot be accomplished in all operating conditions because the energy stored in the leakage inductance is not sufficient to discharge the parasitic capacitances of the switching elements in the resonant leg. When the output current decreases, the energy in the leakage inductance also decreases below the energy level required to obtain zero voltage switching. For that reason, in some designs, the leakage inductance has to be relatively high so that the energy in the leakage inductance will be enough to discharge the parasitic capacitance of the switching element in the resonant leg in all the operating conditions.

In some conditions, such as low amplitude output current through the output choke due to lighter load or due to a higher ripple, the current through the synchronized rectifiers reaches zero before one of the switching elements in resonant leg turns on. At the moment when one of the synchronized rectifiers turns off and the magnetizing current can provide the current to the output inductor, and the additional current above the current demanded by the output inductor will flow into the primary discharging the parasitic capacitances of the primary switching elements to zero.

In U.S. Pat. No. 10,291,140, generally, discharge of the parasitic capacitances across the switching elements of the resonant leg by the magnetizing current and current injection sources starts after the entire energy in the leakage inductance is used and the voltage across the primary switching elements reach the lower level.

In phase-shifted full bridge topology power conversion, there is a need for obtaining soft switching using very high efficiency transformers with low leakage inductance.

### SUMMARY

In an embodiment, the specification describes power converters using soft switching in phase shifted full bridge topology wherein a current injection method is used to obtain zero voltage switching on all the primary switchers in all the operating conditions, wherein the amplitude of current injection is substantially decreased by creating a very good coupling between the primary of the transformer and the current injection winding, while creating a leakage inductance in between the secondary winding and said primary winding the current injection winding. The current injection is activated when the energy contained in the leakage inductance between primary and secondary is not enough to create zero voltage switching conditions for the switching elements. Once activated, the current injection flows preferentially towards the primary winding, discharging the parasitic capacitance reflected across primary switching elements of the resonant leg.

In an embodiment, a method for operating a pulse-shifted full-bridge (PSFB) DC-DC converter includes providing a converter which has a primary side and a secondary side, an input voltage source, defining a primary storage element, and a transformer having at least one primary winding at the primary side and at least one secondary winding at the secondary side, wherein a leakage inductance is formed between the at least one primary winding and the at least one secondary winding. The transformer has at least two current injection windings, wherein the leakage inductance between said current injection windings and the at least one primary winding is smaller than the leakage inductance between the at least two current injection windings and the at least one secondary windings. A bridge is formed by two legs connected in parallel at the primary side, one leg being a linear leg and another leg being a resonant leg. Each leg is formed by a corresponding bottom primary switching element and an upper switching element at the primary side configured in a totem pole arrangement. Common terminals of the two legs are connected to the input voltage source. Shared terminals of the switching elements within one leg, from the two legs, are connected to one end of at least one primary winding and wherein the shared terminals of the switching elements of another leg, from the two legs, are connected to another end of at least one primary winding. Primary switching elements of a given leg, from the two legs, are configured to be complementary to each other during operation of the converter with a period of dead time that includes driving signals from one leg to be phase-shifted with respect to driving signals from another leg. First and second synchronous rectifiers are at the secondary side. At least one output inductor is at the secondary side, wherein a first terminal of the at least one output inductor is connected to a load of the converter, wherein a second terminal of the at least one output inductor is directly connected to one of the common connections of said secondary synchronous rectifiers. The converter further includes a current-injection electronic circuit having two current injection switching elements, respectively corresponding to switching elements in the resonant leg, two current injection capacitors, two current injection diodes, and a voltage-injection voltage source. The two current-injection switching elements are connected to respectively corresponding first terminals of two current-injection windings, wherein each of respectively corresponding second terminals of the two current-injection windings is connected to a corresponding current-injection capacitor from the two current-injection capacitors. A cathode of each of the two current injection diodes is connected to said corresponding current-injection capacitor at the corresponding second terminal and an anode of each of the two current injection diodes is connected to the voltage-injection voltage source. The method includes: (a) switching on an upper primary switching element of the resonant leg and a bottom primary switching element of the linear leg, the upper primary switching element of the resonant leg and the bottom primary switching element of the linear leg defining a first diagonal of the bridge and, while the first synchronous rectifier is on, transferring power from the primary side to the secondary side, wherein said transferring is characterized by linearly changing, with time, a first amplitude of a first current flowing through the at least one output inductor and linearly increasing a second amplitude of a magnetizing current of the transformer to a peak value of the second amplitude; (b) after switching off the bottom primary switching element of the linear leg and turning on the upper primary switching element of the linear leg, continuing the transferring power to the load and continuing the linearly changing of the amplitude, of current flowing through the at least one output inductor, to a lowest value of the first amplitude while maintaining the second amplitude of the magnetizing current at the peak value; and (c) after switching off the upper switching element of the resonant leg, turning on a current-injection switching element corresponding to a bottom switching element of the resonant leg with a time delay during said switching off of the upper switching element, wherein the current injection starts flowing preferentially into the primary winding of the transformer due to a lower leakage inductance between primary windings and current injection winding, discharging a parasitic capacitance reflected across primary switching elements of the resonant leg.

In an embodiment, the method further includes: (d) after switching off the upper switching element of the resonant leg, discharging the parasitic capacitance reflected across primary switching elements of the resonant leg, with additional use of leakage inductance energy; and (e) switching on the lower switching element of the resonant leg at a given voltage level across it. In an embodiment, the method further includes: (f) cyclically repeating at least steps (a) through (c) with the use of the second synchronized rectifier and a second diagonal of the bridge formed by the upper primary switching element of the linear leg and a bottom primary switching element of the resonant leg, and the second synchronous rectifier. In an embodiment, the given voltage level is zero. In an embodiment, the method includes varying an amplitude of the current injection by varying the time delay. In an embodiment, the secondary side of the converter is configured according to a one of a) center tap topology, b) a current doubler topology, and c) a full bridge rectifications. In an embodiment, the method includes tailoring an amplitude of the injection current by varying the time delay to cause a discharge of a parasitic capacitance of a primary switching element of the given leg to zero before said primary switching element turns on. In an embodiment, the method includes using a look up table in a control mechanism, wherein the current injection switching elements are turned on in an operating condition wherein there is not enough energy in said leakage inductance in the transformer to discharge the parasitic capacitance reflected across primary switching elements of the resonant leg to a given voltage level. In some embodiments, the given voltage level is zero.

The above provides the reader with a very brief summary of some embodiments described below. Simplifications and omissions are made, and the summary is not intended to limit or define in any way the disclosure. Rather, this brief summary merely introduces the reader to some aspects of some embodiments in preparation for the detailed description that follows.

### BRIEF DESCRIPTION OF THE DRAWINGS

Referring to the drawings:

FIG. 1 schematically illustrates a circuit configured according to phase shifted topology with current injection;

FIG. 2 illustrates the control signals for the primary switching elements and the control for the current injection circuit of FIG. 1;

FIG. 3A schematically illustrates the FIG. 1 circuit configured according to phase shifted topology with current injection using one of the embodiments in the implementation of the leakage inductance reflected in the secondary windings;

FIG. 3B illustrates one of the implementations of the output choke for leakage inductance reflected in the secondary windings;

FIG. 3C illustrates another implementation of the output choke for leakage inductance reflected in the secondary windings;

FIG. 4A illustrates the voltage at turn on across the switchers in the resonant leg for different output power and different levels of current injection as per example presented herein, wherein the leakage inductance reflected in the secondary is 50 nH;

FIG. 4B illustrates the voltage at turn on across the switchers in the resonant leg for different output power and different levels of current injection as per example presented herein, wherein the leakage inductance reflected in the secondary is 75 nH;

FIG. 4C illustrates the voltage at turn on across the switchers in the resonant leg for different output power and different levels of current injection as per example presented herein, wherein the leakage inductance reflected in the secondary is 100 nH; and

FIG. 4D illustrates the voltage at turn on across the switchers in the resonant leg for different output power and different levels of current injection as per example presented herein, wherein the leakage inductance reflected in the secondary is 125 nH.

### DETAILED DESCRIPTION

Reference now is made to the drawings, in which the same reference characters are used throughout the different figures to designate the same elements. Briefly, the embodiments presented herein are preferred exemplary embodiments and are not intended to limit the scope, applicability, or configuration of all possible embodiments, but rather to provide an enabling description for all possible embodiments within the scope and spirit of the specification. Description of these preferred embodiments is generally made with the use of verbs such as “is” and “are” rather than “may,” “could,” “includes,” “comprises,” and the like, because the description is made with reference to the drawings presented. One having ordinary skill in the art will understand that changes may be made in the structure, arrangement, number, and function of elements and features without departing from the scope and spirit of the specification. Further, the description may omit certain information which is readily known to one having ordinary skill in the art to prevent crowding the description with detail which is not necessary for enablement. Indeed, the diction used herein is meant to be readable and informational rather than to delineate and limit the specification; therefore, the scope and spirit of the specification should not be limited by the following description and its language choices.

Generally, in U.S. Pat. No. 10,291,140 and its continuing application U.S. Pat. No. 11,146,177, concept is presented wherein a pulse of current is injected into the primary winding at a given time and a given amplitude, current which flows initially into the secondary winding and with an amplitude larger than the current flowing in the secondary windings and in the rectifier means placed in the secondary winding. As a result, the current flowing in the rectifier means becomes zero and slight negative, and the means turn off, opening up the secondary loops formed by the secondary winding and the rectifier means and as a result the magnetizing current in the transformer will further flow into the primary winding discharging the parasitic capacitance reflected across the primary winding towards zero. The rectifier means represents any type of rectifying component such as diode or synchronized rectifier. This mode of operation creates zero current through the output rectifier means and zero voltage across the primary switchers similar to the resonant converters. Generally, in the concept presented in U.S. Pat. No. 10,291,140 and its continuing application U.S. Pat. No. 11,146,177, zero voltage switching on the primary switches is accomplished regardless of the leakage inductance in the transformer. With this method, the current injection reflected in the secondary generally has to be larger than the current flowing through the secondary rectifier means. FIG. 11 of U.S. Pat. No. 10,291,140 generally presents a magnetic configuration using several transformers with the primary winding in series and current injection cells per each transformer. In this way, the current in the current injection circuits reduces its amplitude, function of the number of secondary power cells. U.S. Pat. No. 11,763,984 generally presents a magnetic configuration suitable with multi cell magnetic elements, each cell equipped with current injection sources.

The current injection technology described in the U.S. Pat. No. 10,574,148 generally presents a technology in which a pulse of current is injected in a transformer designed to discharge the parasitic capacitance reflected across the primary switchers. In some implementations of the current injection, the energy which energizes the current injection is harvested from the parasitic elements such as the energy from parasitic oscillations. In the full bridge phase-shifted topology, the energy for the current injection is provided by auxiliary windings placed in the transformer. This means that the reduction in power dissipation due to the switching losses is done through energy consumption from the power train. At the system level, this means that the consumption of the energy for the current injection is minimized and used only when zero voltage switching is needed, and it is not accomplished by other methods.

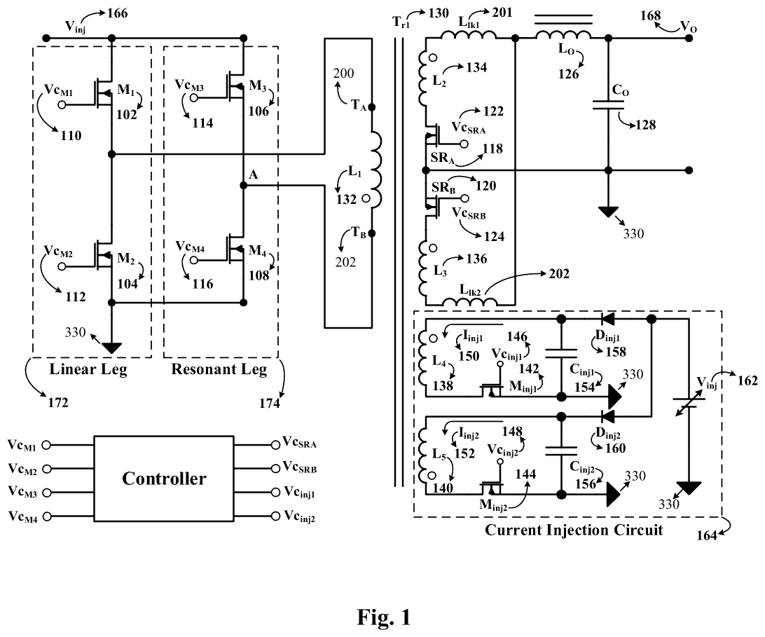

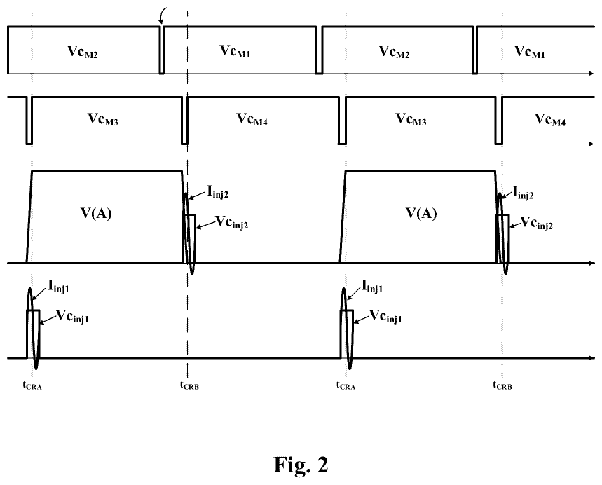

FIG. 1 is a schematic in which full bridge phase shifted topology is used in a 1.2 KW DC-DC converter application with an input voltage from 200V to 525V. The input voltage range of 2.6:1 is relatively large. In the primary there are two totem pole legs, the liner leg formed by M1 (102) and M2 (104) and a resonant leg formed by M3 (114) and M4 (116). The transformer Tr1, 130, has a primary winding L1, 132, and two secondary windings, L2, 134, and L3, 136. In series with the secondary winding there are two additional inductances, referred to as secondary leakage inductances, Llk1, 201 and Llk2, 202. The leakage inductances Llk1 and Llk2 represents the additional leakage inductance in between the secondary windings, L2, 134, and L3, 136, towards the primary winding L1, 132, and towards the current injection windings, L4,138, and L5, 140. Further, the secondary windings in series with the secondary leakage inductances are connected to output inductor, Lo, 126 and further to the output capacitor Co, 128, connected to the output voltage Vo, 168. Two synchronized rectifiers, SRA, 118 and SRB are connected in between the secondary windings L2 and L3 and output ground, 330. In the same transformer Tr1, 130, the current injection windings L4 and L5 are very well coupled with the primary winding L1. The coupling with the secondary windings L2, 134, and L3, 136 effects the optimization of the transformer though some leakage inductance between the secondary winding and the current injection L4, 138, and L5, 140. The leakage inductance in a transformer between primary windings and secondary windings is a consequence of an efficient transformer, and an additional leakage inductance towards the secondary windings is one of the embodiments of this patent.

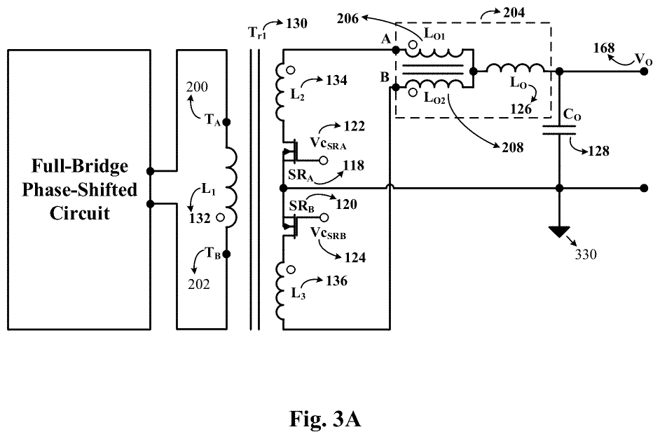

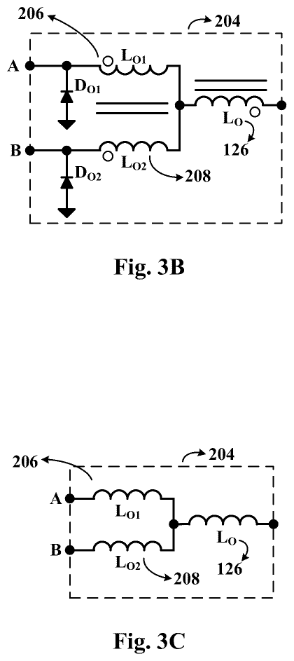

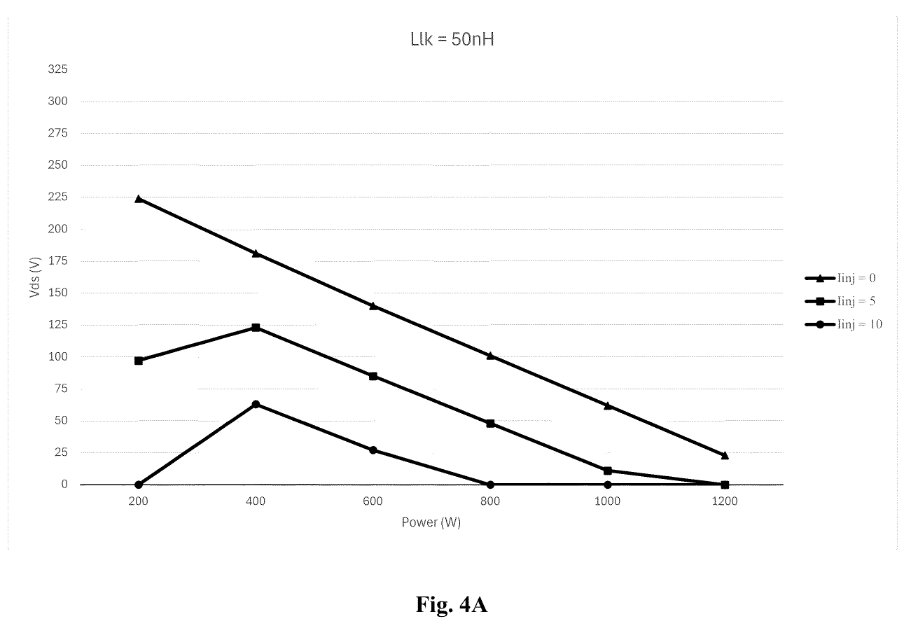

FIG. 3A presents such an embodiment, wherein the leakage inductance is implemented in the output inductor, which reflects as leakage inductance in the secondary windings.

Though in prior art the current injection flows into the secondary winding and is designed to have a larger amplitude that the current flowing into the rectifier means of the secondary winding, turning off the secondary rectifier means and further flowing in the primary winding to discharge the parasitic capacitance across the primary winding to zero.

In embodiments presented in this specification, the current injection winding is very well coupled with the primary winding and there is a leakage inductance in between current injection and secondary winding, and as a result the current injection flows preferentially into the primary winding and its flow is delayed into the secondary winding by said leakage inductance. The current injection which flows into the primary winding discharges the parasitic capacitances reflected across main switchers, discharging said parasitic capacitances to zero. Some of the current injection flows also into the secondary windings though delayed by said leakage inductance reflected into the secondary. The current injection flowing into the secondary does not reach the amplitude necessary to turn off the rectifiers means connected in the secondary windings as is done in the prior art. The rectifier means connected in the secondary windings will be turned off later by the change of the polarity in the secondary winding after the main switchers turn on. In this specification, the leakage inductance reflected into the secondary plays a role in the mode of operation.

The first embodiment of this specification has a very good coupling between the primary winding and the current injection winding. The second embodiment has leakage inductance between the primary and current injection windings towards secondary winding. This can be done through different methods, such as depicted in FIG. 3A.

FIG. 3A presents the circuit from FIG. 1 wherein the secondary leakage inductances llk1, 201 and Llk2, 202 are implemented in the magnetic structure 204 formed by Lo1, 206 and Lo2, 208. The coupling between Lo1 and Lo2 defines the leakage inductance which reflects into the secondary winding. For a high coupling between Lo1 and Lo2, the leakage inductance reflected into the secondary is small and that becomes larger for a poor coupling between Lo1 and Lo2.

The magnetic structure, 204, can be implemented also as shown in FIG. 3B. In FIG. 3B, the Lo1 and Lo2 are coupled between them and also coupled with Lo. During the dead time of operation wherein the energy is transferred from the output choke to the output via SRA and SRB, the auxiliary rectifiers Do1 and Do2 conduct for a short period of time in such way when the power is transferred in forward mode at the next active cycle, Do1 and Do2 are off. By the use of Do1 and Do2, the energy stored in Lo1 and Lo2 is transferred to the output and not reflected back in the transformer and in this way maximizes the effective duty cycle.

In the magnetic structure depicted in FIG. 3C, the three magnetic elements Lo1, Lo2 and Lo are not coupled. Lo1 and Lo2 form the secondary leakage inductance forcing the current injection to reflect towards the primary winding and reducing the current injection flow into the secondary.

The art of the design engineer is to tailor the inductances Lo1 and Lo2 to create the optimal leakage inductance reflected into the secondary without reducing too much of the effective duty cycle and use the current injection when needed to ensure zero voltage switching in the operating conditions wherein the energy in the leakage inductance of the transformer and the reflected inductance from 204, will not contain sufficient energy to ensure zero voltage switching on the switching devices from the resonant leg.

In some applications, however, there is no need for such methods and the leakage inductance between primary and secondary winding is adequate for implementing the embodiments of this patent.

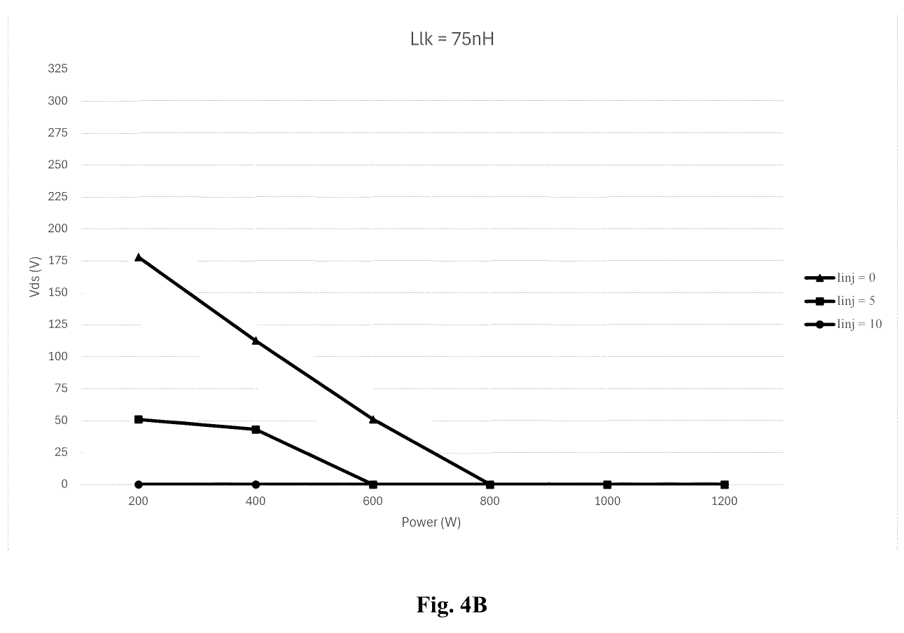

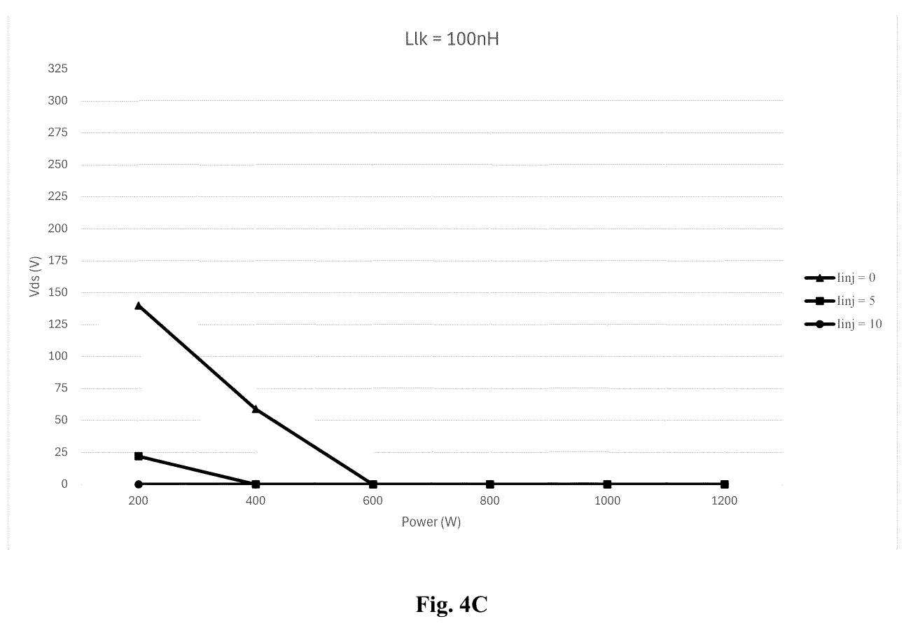

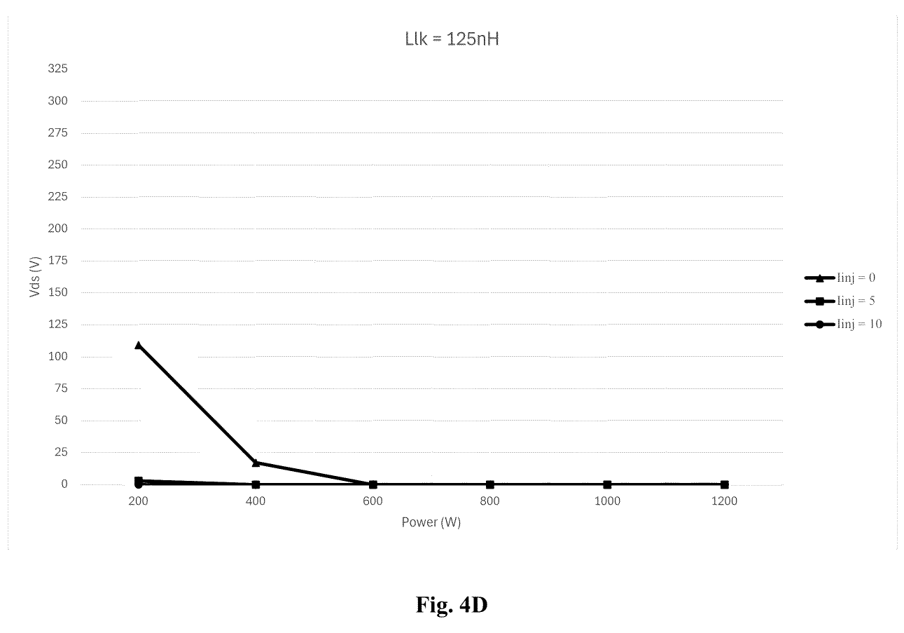

FIGS. 4A, 4B, 4C and 4D present the voltage across the primary switchers at turn on in a 1.2 KW full bridge phase shifted operating at an input voltage of 325V wherein the loading ranges from 200 W to 1.2 KW and the leakage inductance reflected in the secondary winding is 50 nH in FIG. 4A, 75 nH in FIG. 4B, 100 nH in FIG. 4C, and 125 nH in FIG. 4D. In this example, the turns ratio in the transformer is preferably 6:1 and the primary inductance of the transformer is preferably 600 uH.

For a leakage inductance reflected in the secondary of more than 150 nH, which means a coupling coefficient of K=0.995, zero voltage switching across the primary switchers can be obtained at any power level. The leakage inductance reflected in the primary winding is 5.4 uH.

For a leakage inductance reflected in the secondary of 50 nH and without current injection, the voltage across main switchers at turn on decreases from 225V at 200 W to 25V at 1.2 KW, due to the energy contained in the leakage inductance. However, the leakage inductance reflected in the secondary of 50 nH is not sufficient to obtain zero voltage switching at 1.2 KW either. Once a current injection circuit is activated to 5 A amplitude, the voltage across main switchers at turn on decreases by 125V at 200 W. In this specification, primary switches are also referred to as main switchers.

In FIG. 4A, under 400 W of output power, the curve which depicts the voltage at turn on for the primary switchers starts decaying towards lower power, even to zero for output power of 200 W. That is because the magnetizing current becomes larger than the current through the output choke. For a current injection of 10 A, the primary switching elements turn on at zero voltage for output power larger than 800 W. When the leakage inductance reflected into the secondary winding increases to 75 nH, for a current injection of 10 A, the primary switches turn on at zero voltage over the entire output power range as depicted in FIG. 4B. For a leakage inductance reflected into the secondary winding of 125 nH, as depicted in FIG. 4D, the primary switching elements achieve zero voltage switching for a current injection as low as 5 A. For a leakage of 150 nH there is no need of current injection to achieve zero voltage switching for the primary switchers.

One design strategy in full bridge phase shifted topology is for the leakage inductance to be tailored to obtain zero voltage in all the operating conditions, from low power to maximum power. In some applications, an additional inductor is placed in series with the primary winding in order to achieve zero voltage switching in all the operating conditions. This method has a drawback, however, because a larger leakage inductance or a larger effective leakage inductance obtained by an additional inductor in series with primary winding, decreases the effective duty cycle. The reduction of the effective duty cycle forces the designer to reduce the turns ratio in the transformer to regulate the required output voltage at full load for the minimum input voltage. This reduces the overall efficiency due to the use of larger voltage rating rectifier means which have a large voltage drop or a larger impedance in case wherein synchronized rectifiers are utilized. In addition, for a lower turn ratio, the RMS current increases in the primary winding as well.

The traditional solutions of tailoring the leakage inductance in order to obtain zero voltage in all the operating conditions becomes a challenge, especially for a larger input voltage range as in the example above in which the input voltage varies from 200V to 525V. One of the embodiments of this specification keeps the leakage inductance at a lower level, in order to meet the input voltage range. This requires the use of a current injection which is activated as needed towards lower output power. For example, for a very low leakage inductance reflected in the secondary of Llk=50 nH, for power level below the 800 W, a current injection of 10 A or slightly above it is activated to ensure zero voltage switching for loads below 800 W. Above 800 W, zero voltage switching can be achieved for a current injection below 10 A, reflected into the secondary as presented in 4A. In FIGS. 4A, 4B, 4C, and 4D, the current injection is calculated as reflected in the secondary. The current injection reflected in the primary is N\hat{ }2, smaller, wherein N is the turns ratio between primary and secondary which in our example of 1.2 KW example is 6:1.

For a leakage inductance reflected in the secondary of 75 nH, as per FIG. 4B, zero voltage switching is accomplished on power level above 800 W without any current injection. For power levels below 800 W, current injection is necessary, and for power levels below 600 W, a 5 A current injection decreases the turn on for the primary switchers below 50V. A current injection of 10 A ensures zero voltage switching operation over the entire output voltage range. Between 1.2 KW to 800 W, there is no need for current injection. For a current injection of 5 A, zero voltage switching is obtained from 800 W to 600 W. For 10 A current injection the zero-voltage switching is accomplished below 600 W until zero load.

FIG. 1 presents a solution for current injection described by the inventor with a self-adjusting feature. The amplitude of current injection self-adjusts as a function of the voltage across the main switch. For a larger voltage across the main switch, the current injection has a larger amplitude. For a lower voltage across the main switch, when current injection is activated, the amplitude of the current injection becomes smaller. For example, from FIG. 4B wherein the leakage inductance reflected in the secondary is 75 nH, for output power under 800 W, the current injection is activated. The amplitude of the current injection is self-adjusting under 5 A, for output power of 800 W and for output power under 600 W the current injection will self-adjust somewhere between 10 A and 5 A and under 400 W output power the current injection will self-adjust under 5 A. The self-adjusting feature of the current injection minimizes the power requirement for the current injection.

Using a look up table wherein the behavior of the converter is recorded based on experimental results, in a full bridge phase shifted converter with a given leakage inductance reflected in the secondary, the current injection activates as a function of the input voltage level and the output power. Once activated, the current injection self-adjusts to the proper level required to obtain zero voltage switching.

For example, for a leakage inductance of 75 nH reflected in the secondary, the current injection is activated for a power level below 600 W and in between 600 W and 800 W the voltage across the primary switcher should be around 50V, which may not require activation of the current injection. Once the current injection is activated, the amplitude of the current injection self-adjusts to obtain zero voltage switching with minimum power consumption.

In another example, depicted in FIG. 4C, the current injection activates at power under 400 W, because without any current injection, the voltage across the primary switchers at turn on would be slightly above 50V, which is acceptable. Once the current injection circuit is activated, the voltage across the main switchers decays to zero when the main switchers turn on.

A preferred embodiment is fully and clearly described above so as to enable one having skill in the art to understand, make, and use the same. Those skilled in the art will recognize that modifications may be made to the description above without departing from the spirit of the specification, and that some embodiments include only those elements and features described, or a subset thereof. To the extent that modifications do not depart from the spirit of the specification, they are intended to be included within the scope thereof.

What is claimed is:

1. A method for operating a pulse-shifted full-bridge (PSFB) DC-DC converter, the converter comprising:
a primary side and a secondary side;
an input voltage source, defining a primary storage element;
a transformer having at least one primary winding at the primary side and at least one secondary winding at the secondary side, wherein a leakage inductance is formed between the at least one primary winding and the at least one secondary winding;
the transformer having at least two current injection windings, wherein the leakage inductance between said current injection windings and the at least one primary winding is smaller than the leakage inductance between the at least two current injection windings and the at least one secondary windings;
a bridge formed by two legs connected in parallel at the primary side, one leg being a linear leg and another leg being a resonant leg,
wherein each leg is formed by a corresponding bottom primary switching element and an upper switching element at the primary side configured in a totem pole arrangement,
wherein common terminals of the two legs are connected to the input voltage source,
wherein shared terminals of the switching elements within one leg, from the two legs, are connected to one end of at least one primary winding and wherein the shared terminals of the switching elements of another leg, from the two legs, are connected to another end of at least one primary winding,
wherein primary switching elements of a given leg, from the two legs, are configured to be complementary to each other during operation of the converter with a period of dead time that includes driving signals from one leg to be phase-shifted with respect to driving signals from another leg;
first and second synchronous rectifiers at the secondary side;
at least one output inductor at the secondary side, wherein a first terminal of the at least one output inductor is connected to a load of the converter, wherein a second terminal of the at least one output inductor is directly connected to one of the common connections of said secondary synchronous rectifiers; and
a current-injection electronic circuit that includes:
two current injection switching elements, respectively corresponding to switching elements in the resonant leg; and
two current injection capacitors;
two current injection diodes; and
a voltage-injection voltage source;
wherein the two current-injection switching elements are connected to respectively corresponding first terminals of two current-injection windings, wherein each of respectively corresponding second terminals of the two current-injection windings is connected to a corresponding current-injection capacitor from the two current-injection capacitors;
wherein a cathode of each of the two current injection diodes is connected to said corresponding current-injection capacitor at the corresponding second terminal and an anode of each of the two current injection diodes is connected to the voltage-injection voltage source;
the method comprising:
(a) switching on an upper primary switching element of the resonant leg and a bottom primary switching element of the linear leg, the upper primary switching element of the resonant leg and the bottom primary switching element of the linear leg defining a first diagonal of the bridge and,
while the first synchronous rectifier is on, transferring power from the primary side to the secondary side, wherein said transferring is characterized by linearly changing, with time, a first amplitude of a first current flowing through the at least one output inductor and linearly increasing a second amplitude of a magnetizing current of the transformer to a peak value of the second amplitude;
(b) after switching off the bottom primary switching element of the linear leg and turning on the upper primary switching element of the linear leg, continuing the transferring power to the load and continuing the linearly changing of the amplitude, of current flowing through the at least one output inductor, to a lowest value of the first amplitude while maintaining the second amplitude of the magnetizing current at the peak value; and
(c) after switching off the upper switching element of the resonant leg, turning on a current-injection switching element corresponding to a bottom switching element of the resonant leg with a time delay during said switching off of the upper switching element, wherein the current injection starts flowing preferentially into the primary winding of the transformer due to a lower leakage inductance between primary windings and current injection winding, discharging a parasitic capacitance reflected across primary switching elements of the resonant leg.

2. The method of claim 1, further comprising:
(d) after switching off the upper switching element of the resonant leg, discharging the parasitic capacitance reflected across primary switching elements of the resonant leg, with additional use of leakage inductance energy; and
(e) switching on the lower switching element of the resonant leg at a given voltage level across it.

3. The method of claim 2, comprising: (f) Cyclically repeating at least steps (a) through (c) with the use of the second synchronized rectifier and a second diagonal of the bridge formed by the upper primary switching element of the linear leg and a bottom primary switching element of the resonant leg, and the second synchronous rectifier.

4. The method of claim 2, wherein the given voltage level is zero.

5. The method of claim 1, further comprising: varying an amplitude of the current injection by varying the time delay.

6. The method of claim 1, wherein the secondary side of the converter is configured according to a one of a) center tap topology, b) a current doubler topology, and c) a full bridge rectifications.

7. The method of claim 1, further comprising tailoring an amplitude of the injection current by varying the time delay to cause a discharge of a parasitic capacitance of a primary switching element of the given leg to zero before said primary switching element turns on.

8. The method of claim 1, comprising using a look up table in a control mechanism, wherein the current injection switching elements are turned on in an operating condition wherein there is not enough energy in said leakage inductance in the transformer to discharge the parasitic capacitance reflected across primary switching elements of the resonant leg to a given voltage level.

9. The method of claim 8, wherein the given voltage level is zero.
